(19) United States
(12) Patent Application Publication
(10) Pub. No.: US 2014/0120230 A1
(43) Pub. Date: May 1, 2014

(54) NOVEL AND CONVENIENT METHODS FOR MAKING PERSONALIZED WHIPPED CREAM

(71) Applicants: Örn Almarsson, Shrewsbury, MA (US); Bjarki Arnarson, Shrewsbury, MA (US); Halldór Alex Arnarson, Shrewsbury, MA (US)

(72) Inventors: Örn Almarsson, Shrewsbury, MA (US); Bjarki Arnarson, Shrewsbury, MA (US); Halldór Alex Arnarson, Shrewsbury, MA (US)

(21) Appl. No.: 13/660,705

(22) Filed: Oct. 25, 2012

(51) Int. Cl. A23C 13/14

(52) U.S. Cl. CPC A23C 13/14
USPC 426/519

(57) ABSTRACT

An easy-to-use, rapid method of making whipped cream without the use of a mechanical mixing means, and without any pressurized gas or propellant means.

### BACKGROUND OF THE INVENTION

For many years, whipped cream has been enjoyed by many as an ingredient in culinary indulgences, decorative accent on food and drink, or as a topping for favorite desserts. From ice cream stands to restaurants and household kitchens, many popular foods are enjoyed with a generous portion of whipped cream. All too often, desserts are topped with mass-produced cream where the taste and texture are predictable and tedious. Further, the variety of commercially available whipped cream is limited.

Commercially available whipped cream often is sold in volumes too large for individual use and such commercial products are monolithic. For example, the fat content, consistency and sweetness of commercial whipped cream is determined by the manufacturer and, once packaged, cannot readily be changed. Such products do not provide the consumer with an opportunity to adjust the product's characteristics (e.g., fat content, consistency and sweetness) to his or her tastes.

For the more discerning aficionado, only “homemade” fresh whipped cream will suffice.

Unfortunately, many methods of producing homemade whipped cream for domestic or home use employ a rotating agitator blade or some other bulky, expensive and maintenance-intensive mechanical mixing tool to generate turbulence and mix cream while integrating air to form a homogeneous mixture. Moreover, those household methods which do not require cumbersome mechanical mixers (e.g., stirring liquid/fluid cream with a kitchen utensil or shaking in a glass jar) are slow and can lead to fatigue for the home chef.

Thus, there exists a need for new methods of making whipped cream which possess the ability to employ a diverse range of ingredients while also providing low maintenance and ease-of-use.

### SUMMARY OF THE INVENTION

The present invention provides a method of making whipped cream, comprising:
(i) dispensing an amount of liquid heavy cream into a container;
(ii) agitating the liquid heavy cream in the container until the whipped cream is completely formed; and
(iii) extruding the whipped cream from the container;
wherein the liquid heavy cream in step (ii) is agitated without a mechanical mixing means;
further wherein the container does not include a pressurized gas or other propellant means;
further wherein the container is malleable so as to facilitate extrusion via squeezing or crushing; and
further wherein the whipped cream in step (ii) is completely formed in less than 5 minutes.

In another embodiment, the size of the container is less than 20 liquid ounces.

In another embodiment, the ratio of the amount of liquid heavy cream to the volume of the container is between 0.25 and 0.5.

In another embodiment, the liquid heavy cream contains at least about 5 grams of fat per 0.5 liquid ounces.

In another embodiment, the whipped cream in step (ii) is completely formed in less than 2 minutes.

In another embodiment, the ratio of the amount of liquid heavy cream to the size of the container is 0.25.

In another embodiment, further agitation following complete formation of whipped cream in step (ii) does not result in the formation of butter.

In another embodiment, the volume of the container is about 8 fluid ounces and the amount of liquid heavy cream dispensed in step (i) is about 2 fluid ounces.

### DETAILED DESCRIPTION OF THE INVENTION

The term “whipped cream” is defined as aerated liquid/fluid cream that has become sufficiently aerated to no longer act as a liquid or fluid. In accordance with the present invention, the aeration is completed without any mechanical mixing means or other whip/whisk.

The term “mechanical mixing means” is defined as any mechanical or stationary whip or blade used to mix liquid cream and air. Examples include, but are not limited to, whisk, kitchen utensil (e.g., fork, etc.) mixer blade, agitator or the like.

The term “pressurized gas or other propellant means” is defined as a gas under pressure (such as nitrous oxide, argon, nitrogen, carbon dioxide or another appropriate gas) or another propellant (such as liquified gas or an aerosol) which can be used to physically propel and/or aerate liquid cream out of a pressurized container. For the sake of clarity, “pressurized gas” refers to a gas under pressure (such as nitrous oxide, argon, nitrogen, carbon dioxide or another appropriate gas) as commonly used in the art. Further, “other propellant means” refers to a propellant other than a “pressurized gas” and includes, but is not limited to, a liquified gas or an aerosol, as commonly used in the art.

According to the present invention, the container is soft or malleable so as to facilitate extrusion via manual squeezing or crushing. In one embodiment, the container is a vessel, such as a tube, a cylinder or a pouch that is easily sealed or opened. In a specific embodiment, the container is a plastic bottle, such as those commonly used for soda, juice or water beverage bottles. For example, a container can be made of polyethylene terephthalate (PET). Other materials used to make the container can be, for example, high density polyethylene, low density polyethylene, polyvinyl chloride, polypropylene, or polystyrene.

The container of the present invention also facilitates transport of liquid heavy cream without whipping prematurely, such as during transport.

According to the present invention, the container holds a total volume of about 50 liquid ounces, or about 40 liquid ounces, or about 30 liquid ounces, or about 25 liquid ounces, or about 20 liquid ounces, or about 16 liquid ounces, or about 15 liquid ounces, or about 14 liquid ounces, or about 13 liquid ounces, or about 12 liquid ounces, or about 11 liquid ounces, or about 10 liquid ounces, or about 9 liquid ounces, or about 8 liquid ounces, or about 7 liquid ounces, or about 6 liquid ounces, or about 5 liquid ounces.

According to the present invention, the container can be readily sealed or opened with a spill-proof cover. The spill-proof cover can be attached by various means known in the art, such as a twist-off cap or a snap-off lid.

The liquid heavy cream contains from about 35% fat (i.e., butterfat) to about 41% fat. For example, about 35% fat, about 35.5% fat, about 36% fat, about 36.5% fat, about 37% fat, about 37.5% fat, about 38% fat, about 38.5% fat, about 39% fat, about 39.5% fat, about 40% fat, about 40.5% fat, or about 41% fat. The liquid heavy cream is maintained at refrigerated (i.e., between about 33 and about 40 degrees Fahrenheit) temperatures

In another embodiment, one or more additional ingredients can, optionally, be added to the liquid heavy cream. For example, sugar, vanilla, vanilla extract, sweetener (such as, sucralose, fructose, or dextrose, and the like), coloring, etc. The additional ingredients do not act to facilitate mixing, but rather to alter the taste or appearance of the resulting whipped cream. In one specific embodiment, no additional ingredients are added. In another specific embodiment, sugar beads can be used for sweetening. Such sugar beads can also provide an audible cue for the agitation process.

The liquid heavy cream is manually agitated (e.g., shaken) in the sealed container until the whipped cream is completely formed (i.e., no longer fluid). There is an inverse relationship between the intensity of the agitation and the duration of agitation required for complete formation of whipped cream. A reasonable level of agitation intensity results in complete formation of whipped cream with less than about 6 minutes. For example, less than about 6 minutes, less than about 5 minutes, less than about 4 minutes, less than about 3 minutes, less than about 2.5 minutes, less than about 2 minutes, less than about 1.5 minutes, or less than about 1 minute.

Upon completion, the whipped cream can be dispensed readily by opening the container and manually squeezing or crushing the container over the desired object. Once dispensing is complete, the container can be cleaned and re-used or recycled.

In another embodiment, the ratio of the amount (liquid ounces) of liquid heavy cream to the volume (liquid ounces) of the container is between 0.20 and 0.60. For example, the ratio of the amount of liquid heavy cream to the volume of the container is about 0.20, 0.25, 0.30, 0.35, 0.40, 0.45, 0.50, 0.55, or 0.60. In one specific embodiment, the ratio of the amount of liquid heavy cream to the volume of the container is about 0.25.

In determining the optimum ratio of the amount of liquid heavy cream to the volume of the container, it is important to consider several factors for each specific container, including:
(1) the expansion of the liquid heavy cream as it forms whipped cream;
(2) the headspace (air) available in the container;
(3) the duration of time required to agitate the container to complete whipped cream formation; and
(4) the total amount of whipped cream desired.

More specifically, the volume of the liquid heavy cream increases as it is mixed with air. As a demonstrative example only, a container almost filled (i.e., 75% or more by total volume) with liquid heavy cream does not provide the necessary headspace for cream expansion. For example, whipped cream expands by about 1.5- to about 2-fold relative to the un-whipped fluid. As a second demonstrative example, a container filled with liquid heavy cream to a volume between about 60% and about 74% has a low ratio of air to cream. This increases the duration of time required for the agitation process. As a third demonstrative example, a container filled with liquid heavy cream to a volume between about 1% and about 19% has a high ratio of air to cream. This results in quicker agitation duration, but the total amount of whipped cream produced is small.

In another embodiment, the liquid heavy cream contains at least about 5 grams of fat per 0.5 liquid ounces. In another embodiment, the liquid heavy cream contains about 5 grams of fat per 0.5 liquid ounces. In another embodiment, the liquid heavy cream contains about 6 grams of fat per 0.5 liquid ounces. In another embodiment, the liquid heavy cream contains about 7 grams of fat per 0.5 liquid ounces.

In another embodiment, further agitation following complete formation of whipped cream in step (ii) does not result in the formation of butter. One of the advantages of the present invention is that the methods described herein enable the production of whipped cream without the risk of funning butter upon excessive agitation. While not wishing to be bound by theory, it is believed that upon completion of the whipped cream process, there is no longer any liquid cream (i.e., no longer fluid) present or any significant head space. Thus, additional churning, which is required for butter formation, is prevented.

In another embodiment, the amount of liquid heavy cream dispensed into the container is from about 1 liquid ounce to about 25 liquid ounces. For example, about 1 liquid ounce, about 2 liquid ounces, about 3 liquid ounces, about 4 liquid ounces, about 5 liquid ounces, about 6 liquid ounces, about 8 liquid ounces, about 10 liquid ounces, about 15 liquid ounces, about 20 liquid ounces, or about 25 liquid ounces.

In another embodiment, the volume of the container is about 4 fluid ounces and the amount of liquid heavy cream dispensed in step (i) is about 1 fluid ounce. In another embodiment, the volume of the container is about 8 fluid ounces and the amount of liquid heavy cream dispensed in step (i) is about 2 fluid ounces. In another embodiment, the volume of the container is about 12 fluid ounces and the amount of liquid heavy cream dispensed in step (i) is about 4 fluid ounces. In another embodiment, the volume of the container is about 16 fluid ounces and the amount of liquid heavy cream dispensed in step (i) is about 5.3 fluid ounces.

In another embodiment, the present invention provides a method of making whipped cream, wherein the container is charged only with an amount of liquid heavy cream (and the air necessarily present) and the container is sealed with a spill-proof cover. No whisk, mixing blade, fork or any other mechanical mixing means is placed in the container. No additional ingredients are added. The container is agitated manually until the whipped cream is completely formed. Depending upon the agitation intensity, the agitation can be completed, for example, in less than about 6 minutes, less than about 5 minutes, less than about 4 minutes, less than about 3 minutes, less than about 2 minutes, or less than about 1 minute.

In another embodiment, a vacuum can be applied to the container following the dispensing step to remove air in the container prior to sealing with an air-tight seal. Such a vacuum-sealed container can be used to prevent premature whipping and/or to provide long-term stability (i.e., reduce oxidation). When whipping is desired, the vacuum seal can be broken, the container can be closed, and agitation can begin in accordance with the methods described herein.

As described above, many previously known methods of making whipped cream require the use of mechanical mixing means or pressurized gases. Thus, the present invention provides methods that are energy sparing and environmentally friendly.

### EXAMPLES

Experiments were run with the help of a Wristshaker (Burrell Wrist-Action® Laboratory Shaker, Burrell Scientific) apparatus. The machine, which can hold multiple different bottles at a time, shakes at a fixed speed with amplitude of a few inches, consistent with hand shaking.

Agitation using the wristshaker apparatus was validated with a comparison of the manual shaking of 8 oz. containers with 2 oz. Land′O′Lakes heavy whipping cream (5 g fat in 0.5 oz). Both the wristshaker apparatus and the manual shaking produced whipped cream after about 2 minutes.

Several factors were chosen for further analysis, including time and texture dependence on the following factors:
(1) Volume of liquid cream, 2-5 oz. in increments of 1 oz., at 8 oz. total volume of bottle (PET bottles were used).
(2) Presence of beads of sugar (spheres ca. 2 mm in diameter) in 8 oz. bottle, using the four different volumes in (1).
(3) Volume ratio liquid to total, using a 16.9 oz. bottle with a previously tested liquid volume in (1). (4 oz.; 4/16.9˜1/4 volume fill).

Texture was generally a qualitative assessment based on no flow from an open, inverted bottle that was tapped and shaken gently. The flow of mostly complete whipped cream was that of a heavy syrup. The flow of completely whipped cream was essentially absent, and required pressing of the bottle to expel the contents. The form of the cream expelled under the latter conditions was exactly that of the opening: Round complete rope-like fluffy cream. In no case was it possible to over-whip to a buttery texture. See results in Table 1.

TABLE 1

| | | Liquid | | Time to no- | |
|---|---|---|---|---|---|
| | Container | cream | | flow | |
| | volume | volume | Sugar | endpoint | Notes on |
| | (oz.) | (oz.) | beads | (minutes) | Texture and Taste |
| 1 | 8 | 2 | No | 1.75 | Good texture, not sweet |
| 2 | 8 | 4 | No | 3.75 | Comparable to 1 |
| 3 | 8 | 2 | Yes | 1.75 | Sweet, intact beads felt |
| | | | | | in mouth |
| 4 | 8 | 4 | Yes | 4 | |
| 5 | 16.9 | 4 | Yes | 2 | Similar to 1 |

Table 2 shows additional data where the liquid cream was dispensed into the container and allowed to sit refrigerated, overnight. The sugar beads were replaced with chocolate “Jimmies”.

TABLE 2

| | | Liquid | | Time to no- | |
|---|---|---|---|---|---|
| | Container | cream | | flow | |
| | volume | volume | Choc. | endpoint | Notes on |
| | (oz.) | (oz.) | Jimmies | (minutes) | Texture and Taste |
| 6 | 8 | 3 | No | 3 | Similar to 1 and 2 |
| 7 | 8 | 5 | No | 6 | Whipped cream fills |
| | | | | | the bottle |
| 8 | 8 | 3 | Yes | 3 | Homogeneous choc. |
| | | | | | bits, sweet |
| 9 | 8 | 5 | Yes | 6 | Improved texture |
| | | | | | relative to sample |
| | | | | | without beads |

### Conclusion

Sugar beads/chocolate “Jimmies” did not significantly alter duration of agitation. The presence of additional ingredients were able to alter the color and sweetness of the whipped cream. Hence, color and sweetness can be modified to suit individual tastes.

Beads may have helped texture, especially at the highest liquid cream-to-total volume ratio. Though the sugar beads did not seem to affect the time of shaking required for a given volume and volume ratio, there is a possibility of improved texture with the sugars creating networks of polymers with the aqueous components of the stable cream emulsion. It was important to facilitate efficient introduction of the air into the cream when the headspace is limited. Note that there is essentially no headspace left when a volume ratio of 5:8 was used.

Time to endpoint of whipping (‘no-flow’) depended strongly on the volume ratio: The smaller the liquid to total volume, the faster the whipping. The time increased in near-exponential fashion as less air was available (>5 liquid cream/8 volume units).

At a volume ratio of about 1/4, the walls of the bottle became covered with cream, leading to some loss on walls and inefficiency in expelling the whipped product. A high volume was also associated with inefficiency in space usage and in shipping.

There was a range of optimal volume ratios between 0.5 and 0.25, where time of shaking was acceptable but yet the efficiency of space usage was efficient.

1. A method of making whipped cream, comprising:
(i) dispensing an amount of liquid heavy cream into a container;
(ii) agitating the liquid heavy cream in the container until the whipped cream is completely formed; and
(iii) extruding the whipped cream from the container;
wherein the liquid heavy cream in step (ii) is agitated without a mechanical mixing means;
further wherein the container does not include a pressurized gas or other propellant means;
further wherein the container is malleable so as to facilitate extraction via squeezing or crushing;
further wherein the whipped cream in step (ii) is completely formed in less than 5 minutes; and
wherein further agitation following complete formation of whipped cream in step (ii) does not result in the formation of butter;
further wherein the volume of the container is less than 20 fluid ounces; and
further wherein the ratio of the amount of liquid heavy cream to the volume of the container is between 0.25 and 0.5.

2. (canceled)

3. (canceled)

4. The method of claim 1, wherein the liquid heavy cream contains at least about 5 grams of fat per 0.5 fluid ounces.

5. The method of claim 4, wherein the whipped cream in step (ii) is completely formed in less than 2 minutes.

6. The method of claim 5, wherein the ratio of the amount of liquid heavy cream to the volume of the container is 0.25.

7. (canceled)

8. The method of claim 1, wherein the volume of the container is about 8 fluid ounces and the amount of liquid heavy cream dispensed in step (i) is about 2 fluid ounces.

9. The method of claim 1, wherein the whipped cream in step (ii) is completely formed in less than 4 minutes.
